(19) United States
(12) Patent Application Publication
(10) Pub. No.: US 2012/0056711 A1
(43) Pub. Date: Mar. 8, 2012

(54) NETWORK-ENABLED VALVE MANAGEMENT SYSTEM

(75) Inventors: Michael Hanrahan, Port Coquitlam (CA); Raymond Wood, Coquitlam (CA)

(73) Assignee: QMI Manufacturing Inc., Coquitlam British Columbia (CA)

(21) Appl. No.: 13/319,516

(22) PCT Filed: Oct. 9, 2009
(86) PCT No.: PCT/CA09/01433

§ 371 Date: Nov. 8, 2011

Related U.S. Application Data
(60) Provisional application No. 61/173,840, filed on Apr. 29, 2009.

(51) Int. Cl. G05B 23/02

(52) U.S. Cl. 340/3.4

(57) ABSTRACT

A system for remotely operating endpoint devices, such as valves for utility services, comprises a server, one or more network access hubs, and one or more endpoint devices. The network access hubs communicate with the server through a network and communicate wirelessly with the endpoint devices. The network access hubs transmit instructions to the endpoint devices to control the operation of the endpoint devices. The network access hubs may also comprise earthquake detection circuits to detect possible earthquakes and transmit instructions to the endpoint devices to close valves accordingly.

### FIELD OF THE INVENTION

The present invention relates to automatic control of valves. In particular, the present invention relates to automatic control of valves for gas, oil, water or other fluids.

### BACKGROUND OF THE INVENTION

Valves are typically used to control utility service (such as gas or water) to customers. For example, quarter-turn valves are commonly used for gas and water connections. Such valves are usually operated manually, with a technician turning a handle to control the flow of the utility service.

Traditionally, to stop or restore gas, water, or other utility service to a customer, a utility company would send a technician to the location to manually unlock and open, or close and lock a valve. There are a number of costs associated with this approach, including labour cost (including time required for travel and for completing the job) and vehicle cost (including fuel and maintenance cost).

### SUMMARY OF THE INVENTION

The objectives of the present invention include the following: (1) eliminate the need for service visits to stop, limit, or restore gas, water, or utility service; (2) provide mass emergency utility shut-off capabilities; (3) provide automatic utility shutoff in an earthquake; (4) provide a network of earthquake detectors that can operate independently and collectively; (5) provide a means for rationing utility service; (6) provide a means for automatic utility “prepaid” service; and (7) provide automatic “intermittent” or time-limited utility service.

In one aspect of the invention, a system for remotely operating endpoint devices comprises a server, one or more network access hubs, and one or more endpoint devices. Each of the network access hubs comprises a network interface for communication with the server over a network, a microprocessor, a hub transmitting means, and a hub power supply. Each of the endpoint devices comprises an endpoint receiving means for receiving wireless communications comprising instructions from the hub transmitting means of one or more of the network access hubs in wireless communications range, a microcontroller for processing the instructions and executing the instructions, and an endpoint power supply.

In another aspect, the endpoint devices further comprise a valve motor for controlling one or more valves and a motor driver, wherein the motor driver receives electrical signals from the microcontroller upon execution of the instructions by the microcontroller and wherein the motor driver effects movement of the valve motor in accordance with the electric signals. The valves may be used to restrict the flow of one of the following utility services: gas, oil, and water.

In yet another aspect, the one or more network access hubs further comprise an earthquake detection circuit, wherein the earthquake detection circuit sends an earthquake warning to the microprocessor upon detection of a possible earthquake.

In a further aspect, one or more of the endpoint devices comprises a light source for use in street lighting.

In another aspect, a method of remotely controlling endpoint devices comprises the steps of a server communicating with one or more network access hubs through a network, the one or more network access hubs wirelessly transmitting instructions to one or more endpoint devices through a hub transmitting means, the one or more endpoint devices receiving the instructions from the network access hubs through an endpoint receiving means, and the one or more endpoint devices implementing the instructions.

In a further aspect, a method of remotely controlling a valve in an endpoint device in response to a possible earthquake comprises the steps of a server communicating with a network access hub through a network, the network access hub detecting a possible earthquake through an earthquake detection circuit, the network access hub transmitting information regarding the possible earthquake to the server through the network, the network access hub wirelessly transmitting instructions to the endpoint device through a hub transmitting means, wherein the instructions comprises instructions regarding control of the valve in response to the possible earthquake, the endpoint device receiving the instructions from the network access hub through an endpoint receiving means, and the endpoint device controlling the valve in accordance with the instructions.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

FIG. 1 is a schematic diagram of a valve of the present invention in accordance with the preferred embodiment;

FIG. 2 is a schematic diagram of a network access hub of the present invention in accordance with the preferred embodiment;

FIG. 3 is a schematic diagram showing the network structure of the present invention in accordance with the preferred embodiment;

FIG. 4 is a schematic diagram showing an alternative network structure of the present invention; and

FIG. 5 is a schematic diagram showing a second alternative network structure of the present invention.

### DETAILED DESCRIPTION OF THE PREFERRED EMBODIMENT

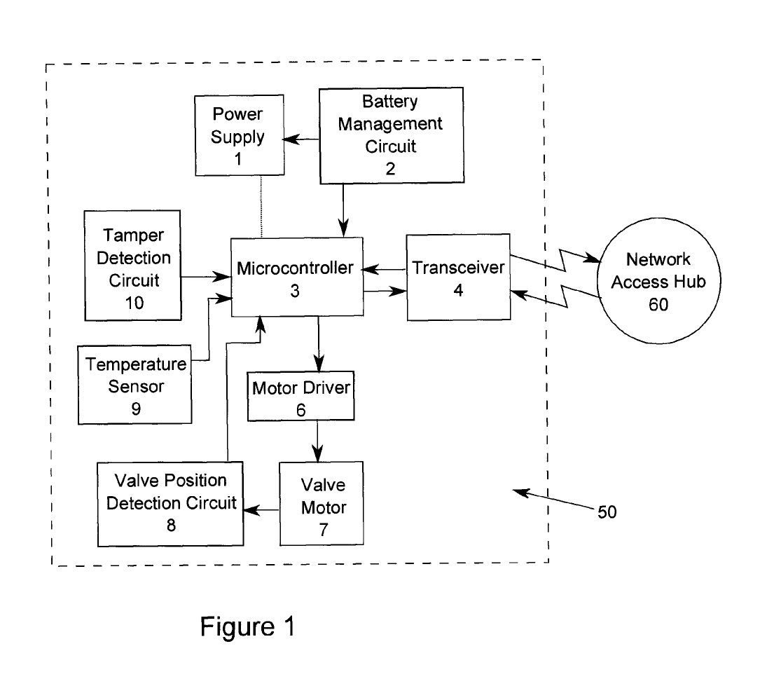

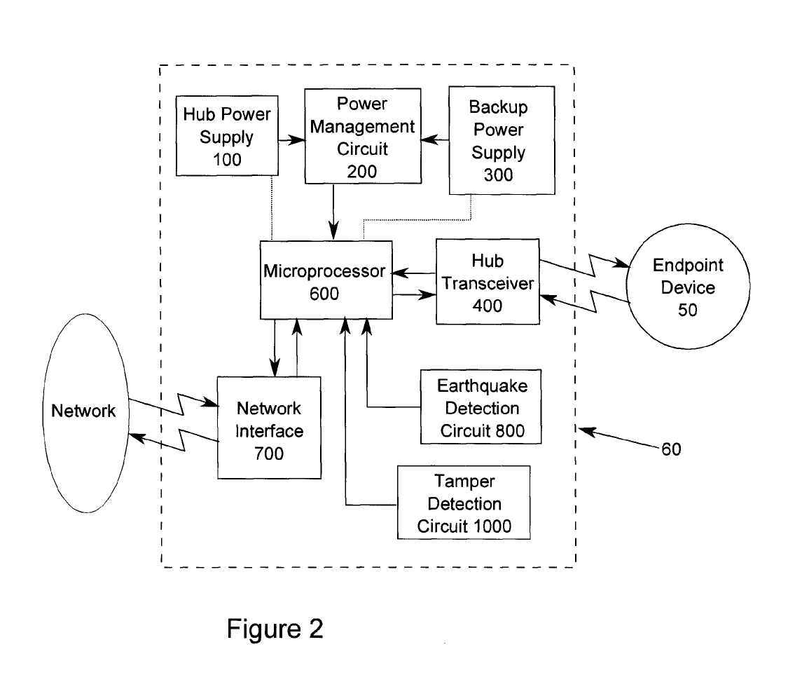

Referring to FIGS. 1 and 2, the present invention comprises one or more endpoint devices 50 and one or more network access hubs 60. Referring in particular to FIG. 1, the endpoint device 50 is preferably a valve for controlling gas, oil, water, or some other utility service. In the preferred embodiment, the endpoint device 50 is an electrically operated, battery-powered valve, although the valve may also be pneumatically actuated instead. The valve is preferably a quarter-turn ball valve or a butterfly valve with a position sensor consisting of limit switches and rotary encoder for accurate position determination. In the case where the endpoint device 50 is a valve, it comprises a transceiver 4, a motor driver 6, a valve motor 7, a microcontroller 3, and a power supply 1.

The transceiver 4 is preferably a two-way radio that provides a secure two-way wireless radio link between the endpoint device 50 and the network access hub 60. Preferably, this link is encrypted to prevent eavesdropping and to ensure that there is no unauthorized access to either the endpoint device 50 or the network access hub 60. It is possible to use a receiver only, instead of the transceiver 4, in which case the endpoint device 50 would only be able to receive data from the network access hub 60, and not transmit.

The microcontroller 3 is preferably a low-power processor pre-programmed with firmware to manage and control the operation of the endpoint device 50, based on instructions and communications received from the network access hub 60 via the transceiver 4. The valve motor 7 causes the physical operation of the valve. For gas and water connections, the valve is typically a quarter-turn ball valve, although butterfly valves may also be used. The motor driver 6 comprises circuitry to translate the logic-level signal from the microcontroller 3 into movement of the valve motor 7. For an electrically driven valve, this would include power conditioning to achieve proper isolation from the power supply 1 and to achieve the desired voltage and frequency. The motor driver 6 further comprises circuitry to control the direction of valve motor 7 rotation. For a stepper-motor, the microcontroller 3 comprises circuitry to control the rotation sequence to allow for precise control over the setting of the angle of the valve.

The power supply 1 is preferably a battery, but any other means for providing power is suitable.

The endpoint device 50 may also comprise a valve position detection circuit 8. The valve position detection circuit 8 may provide an accurate indication of the rotation of the valve by incorporating a resistive element that varies a known resistance as the valve turns. The valve position detection circuit 8 may also contain a pulse counter or a rotary encoder in combination with limit switches at the open and closed positions. The limit switches provide an absolute reference for the open and closed positions and provide a calibration reference for the variable position sensor.

The endpoint device 50 may also comprise a tamper detection circuit 10 to alert the system to unauthorized access to the physical hardware. This may be accomplished in 3 ways. The first method is to employ an electro-mechanical switch and/or an optical sensor that will trigger an intrusion alarm message to a server if the valve enclosure is opened. The second method is to employ a motion sensor in the valve to respond to unexpected motion that could indicate attempted removal of the valve. The third method is for the server to monitor the valve and report an error message when the valve stops responding to information requests.

The endpoint device 50 may also comprise a temperature sensor 9 to monitor the temperature of the endpoint device 50.

Further, the endpoint device 50 may comprise a battery management circuit 2. It maintains safety and reliability by limiting current to protect the power supply 1 from a short circuit. It may also provide the necessary isolation between the various power supply rails so that excessive noise or ringing on one supply will not interfere with other supplies. It will also monitor the battery voltage to report back to the server, and if the battery voltage ever drops below a certain threshold, it will send an alert to the server.

In addition to valves, the endpoint device 50 may also comprise metering equipment, sensors (for monitoring flow, motion, temperature, etc.), signalling equipment (sirens, lights, etc.), fans, other motors, solenoids, pumps, or barriers. It may also comprise a light source that may be used for street lighting. The operation of the metering equipment, sensors, signalling equipment, fans, solenoids, pumps, barriers, and/or light source would be controlled through communications with the network access hub 60.

Each endpoint device 50 is preferably provided with a unique identifier, which could be used to identify the type of endpoint device (e.g. valve, signalling device, pumps, etc.). If the endpoint device 50 is a sensor or meter, it would operate in a very similar way to a valve. However, instead of primarily receiving instructions through the transceiver 4 from the network access hub 60, it would be primarily transmitting data through the transceiver 4 to the network access hub 60. This data would comprise of the information collected by the sensor or meter. Other endpoint devices would behave as valves would. For example, a command normally interpreted as “OPEN” by a valve could be interpreted as “START” by a signalling device (and it would start flashing a light, sounding a siren, etc.). Similarly, a command normally interpreted as “CLOSE” by a valve could be interpreted as “STOP” by the signalling device (stopping the flashing of the light, stopping the siren, etc.).

Referring to FIG. 2, the network access hub 60 is a low-power DC device that can draw its power from a variety of DC power sources. A hub power supply 100, such as a switching AC-DC power supply, is included with the network access hub 60; however, any power source capable of providing enough DC power to the unit may be used instead or as a backup power source. Such sources could include any combination of batteries, solar cells, wind turbines, fuel cells, and generators.

The network access hub 60 also comprises a hub transceiver 400, a network interface 700, and a microprocessor 600. The hub transceiver 400 provides a secure two-way wireless radio link between the endpoint device 50 and the network access hub 60. Preferably, this link is encrypted to prevent eavesdropping and to ensure that there is no unauthorized access to either the endpoint device 50 or the network access hub 60. It is possible to use a transmitter only, instead of the hub transceiver 400, in which case the network access hub 60 would only be able to transmit data to the endpoint device 50, and not receive. The data comprises instructions from the network access hub 60 to the endpoint device 50 regarding the operation of the endpoint device 50.

The network interface 700 provides a secure connection to a data network. Since the network access hubs 60 are likely to be distributed over a large geographical area, a mobile data solution is preferably used. This would be either a satellite modem, or a mobile data (GSM/GPRS/EDGE, etc.) modem connected to the Internet, or directly to a private network to which the server is also connected. Depending on the network configuration, this could also be some other wireless configuration (e.g. Wi-Fi, Wi-Max, Zigbee, etc.) or a hard-wired configuration (e.g. Ethernet, SCADA, etc.).

The microprocessor 600 comprises the firmware that manages the network access hub 60. It manages its own functions and keeps track of the endpoint devices 50 within its range, so it preferably has more computing power and memory than the microcontroller 3 that would be found in the endpoint devices 50.

The network access hub 60 may also comprise an earthquake detection circuit 800. It uses an accelerometer to measure the magnitude, direction, and frequency of ground oscillations. Oscillations that fall within the limits set by the ASCE 25-06 standard will be considered an earthquake and trigger a broadcast command that will cause all endpoint devices 50 controlled by the network access hub 60 to close automatically. ASCE 25-06 is one example of a common “local standard” for earthquake-actuated valve closure. Because the limits are set in software, these can be easily reconfigured to meet any other limits required for other jurisdictions or applications, and also easily updated to meet any other current or future earthquake detection standards that are based on measuring any combination of magnitude, direction, and/or frequency (period) of ground movement. A message is also sent back to inform the server of the situation. The server can analyze these messages and when enough network access hubs 60 report an earthquake, the server can take the proactive step of telling all network access hubs 60 within the affected geographic area to shut their respective endpoint devices 50 before the earthquake arrives. Alternatively, firmware can be configured so that the accelerometer will respond only to oscillations that fall within the limits set by other standards, or as required in specific cases.

The earthquake detection circuit 800 also incorporates P-wave identification and early warning capability. It will identify P-waves and compare the horizontal and vertical components of a ground oscillation to distinguish them from low-energy S-waves. This will provide an advance warning of an incoming earthquake. The network access hub 60 can use this information to automatically actuate valves or other systems (e.g. sirens, lights, door openers, etc.) in endpoint devices 50 before the damaging S-waves arrive.

The network access hub 60 may also comprise a power management circuit 200 to manage the hub power supply 100 and any backup power supplies that may be required. Circuitry within the network access hub 60 are typically 12 VDC or less, so the incoming main power supply can be from a mains power supply “brick” with a 9-12 VDC output, from a solar panel, or any other source that can provide 9-12 VDC. The circuitry in the power management circuit 200 will handle any voltage monitoring or conditioning required by the network access hub 60. It will also handle the switch-over from the hub power supply 100 to any backup power supply when required. In the case where the backup power supply is a battery, the power management circuit 200 will maintain the appropriate charge method for the chemistry of the battery chosen.

The network access hub 60 may also comprise a backup power supply 300, which may be used in the event that the hub power supply 100 fails. Its operation would be controlled by the power management circuit 200 as needed.

Further, the network access hub 60 may comprise a tamper detection circuit 1000. It may comprise any combination of limit switches, optical sensors, and/or motion sensors. If any of these devices detect unauthorized “tampering”, they will cause a fault condition in the microprocessor 600, which will immediately inform the server and alert any users logged into the system.

Limit switches are configured in such a way that the switch arm is normally held in by the enclosure of the network access hub 60 and will be released if the enclosure is opened, causing a state change within the switch.

Optical sensors may be configured in three ways. The first method is to provide a certain logic state dependent on the ambient light that is detected. The first state, low-light, would exist when the enclosure is closed. Opening the enclosure in most environments would cause a different light condition that would result in a change in logic state from the sensor. The second method is to utilize a beam source directed at the optical sensor with a barrier integrated into the enclosure that would either break or make the beam when the enclosure is tampered with, resulting in a change in logic state from the sensor. The third method also employs a beam, but utilizes a reflective surface integrated into the enclosure in such a way that the beam is normally directed back to the sensor, but if the enclosure is tampered with, the reflective surface would no longer direct the beam back to the sensor.

Motion sensors would detect unexpected, non-earthquake movement to the enclosure and cause a tamper fault. This could be a separate vibration sensor or switch (e.g. a mercury switch or similar). The integrated accelerometer for the earthquake detection circuitry 800 could also be utilized in this manner in addition to its earthquake detection role.

Alternatively, the network access hub 60 could exist not as a physical device but as a virtual machine. The core functions of the network access hub 60 would be integrated into software running on a computer. The hub transceiver 400 may either be a piece of dedicate hardware connected to the computer through a standard connection or as an “expansion card” for a standard bus-type (PCI, PCMCIA, etc.). The endpoint devices 50 could also be reconfigured to use a standard wireless networking configuration (e.g. Wi-Fi), in which case the computer could access its endpoint devices 50 through a standard wireless access point connected on a LAN/WAN or even directly through an integrated (or add on) wireless network adapter. The earthquake detection circuitry 800 could also exist as a piece of dedicated hardware attached to the computer, or it could exist as a separate device. This setup would provide a potential means for the user to access and control his or her own “subnet” of valves, sensors, or other endpoint devices over a network (e.g. Internet). When configured as part of the larger network, this virtual machine setup would be transparent to the central server. The message transactions between the virtual machine and the real hardware version of the network access hub 60 would be identical.

A typical application would see network access hubs 60 deployed in a “cellular” grid in a geographic area to maximize the wireless coverage for the endpoint devices 50. Within each grid, the endpoint devices 50 would be installed on main water and/or gas supply lines to buildings. Software running in a central location would allow an authorized user to access each valve individually to open or close it as required.

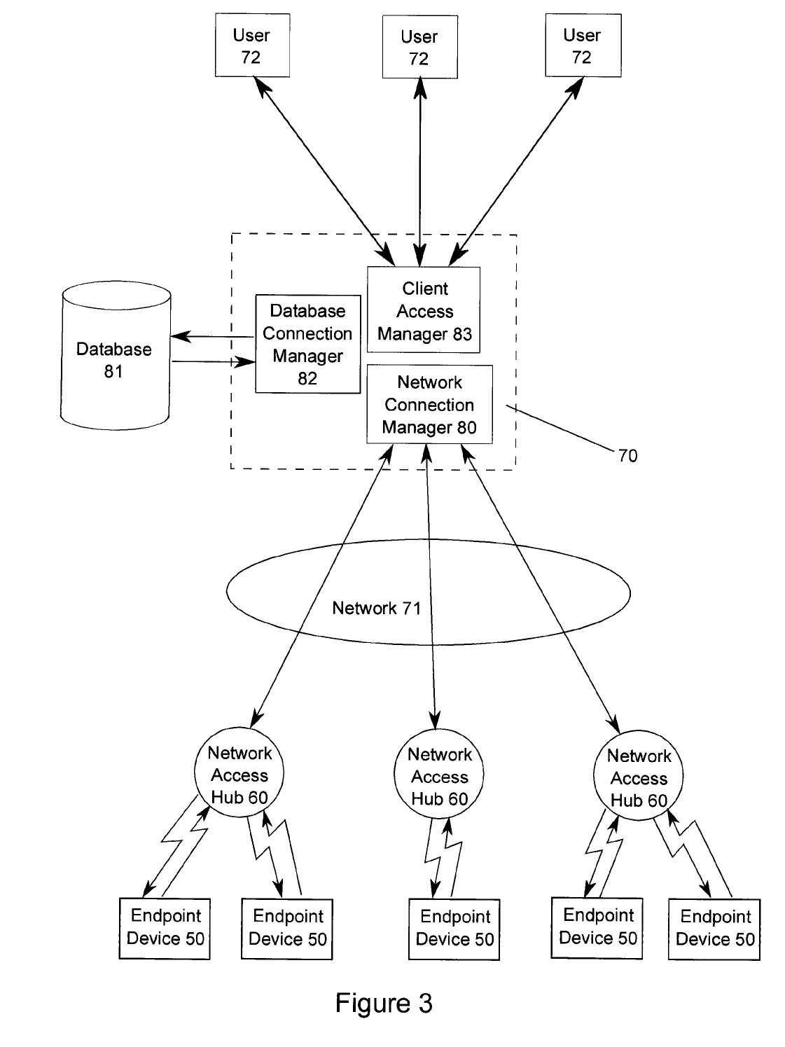

Referring to FIG. 3, the system may also comprise a server 70 at a central location. The server communicates with the network access hubs 60 and comprises a network connection manager 80, a database 81, a database connection manager 82, and a client access manager 83.

The network access manager 80 maintains the routing information, authorization, and data encryption between the server 70 and the network access hubs 60. This communication may be through a network 71, which may be a public or private network. The network 71 may be the Internet, a WAN, a LAN, or some other form of network. It attempts to reestablish dropped connections and provides a listening port to which the network access hubs 60 can reconnect on their own.

The database connection manager 82 maintains a link to the database 81. It allows the user to use an existing database or to provide a new blank database. The database 81 cross-references system-specific data (valve/hub serial numbers, valve/hub relationships, etc.) with customer-specific information. This could include physical address of the location where the endpoint device 50 is installed, GPS co-ordinates (this information could also come directly from the endpoint device 50), customer name, customer account information (account number, billing, usage history, etc.)

The client access manager 83 authenticates clients attempting to log into the server 70 and restricts access to information or operations based on permissions.

The server 70 may also comprise core software that contains core operations for the server 70. It is “wrapped” by the network access manager 80, the database connection manager 82, and the client access manager 83 as a security measure to provide isolation from the outside world.

Preferably, the system further comprises client access software to provide a user interface for the end-user. It may include a graphical user interface to display information provided by the server 70, allow for control of the endpoint devices 50 and the network access hubs 60, and access the database 81. Different client applications can be developed for various platforms (PC, Mac, handheld computer, smart-phone, etc.) or for specific applications with limited functionality (e.g. emergency services).

A typical transaction would see a user log into the system from client software. After the user is authenticated, the user can retrieve information and perform operations on the endpoint devices 50 or access the database 81.

For example, if a user 72 wished to close a valve, the transaction would proceed as follows:
1. The user 72 would pull up a customer record from the database 81 and then issue a “close valve” command on this record.
2. The server 70 would pass this information to the network connection manager 80, which would pull the routing information from the database 81 and then issue the command across the network to the correct network access hub 60.
3. The network access hub 60 instructs the valve of the appropriate endpoint device 50 to close. When the valve is closed, it may report back to the network access hub 60, which reports back to the network access manager 80, which in turn passes it along to the server 70. The database 81 is updated, and the server 70 broadcasts an update message to all users logged in that the valve status has changed to closed.

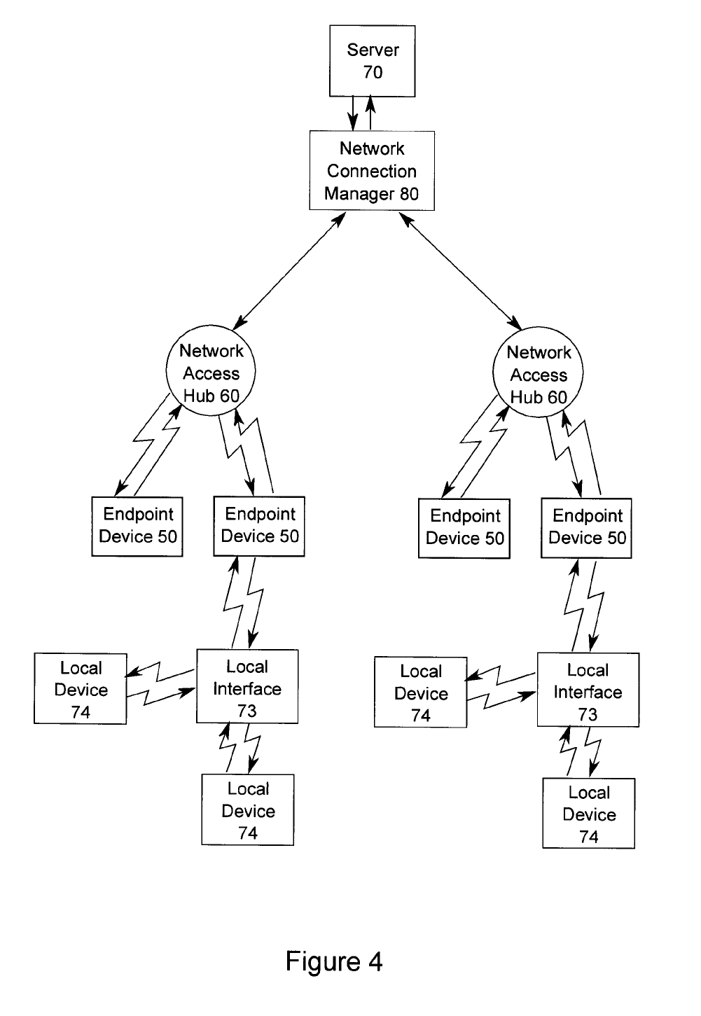

An alternate network structure is illustrated in FIG. 4, where the server-hub-valve relationship is maintained, but remote open/close capabilities of the valve are also accessible by a local subnet of devices through a local interface 73 to automatically shut the valve off in an emergency, or to allow the user to open and close the valve whenever the service is not required as a safety and/or conservation measure. The local interface 73 may also incorporate an alarm monitoring panel interface so that it may be controlled by a third party monitoring company or configured to automatically close the valve when the alarm for the site is armed in “away” mode, and to automatically reopen the valve when the alarm is disarmed. The local interface 73 may also be used to communicate and/or control local devices 74. Examples of local devices 74 would be fire alarms, carbon monoxide detectors, gas leak detectors, water leak sensors, etc. In this scenario, the server may maintain master control over the system and can override, or lock out, commands from local sources if required. This may be accomplished by giving instructions from the server with higher priority than instructions from the local devices 74.

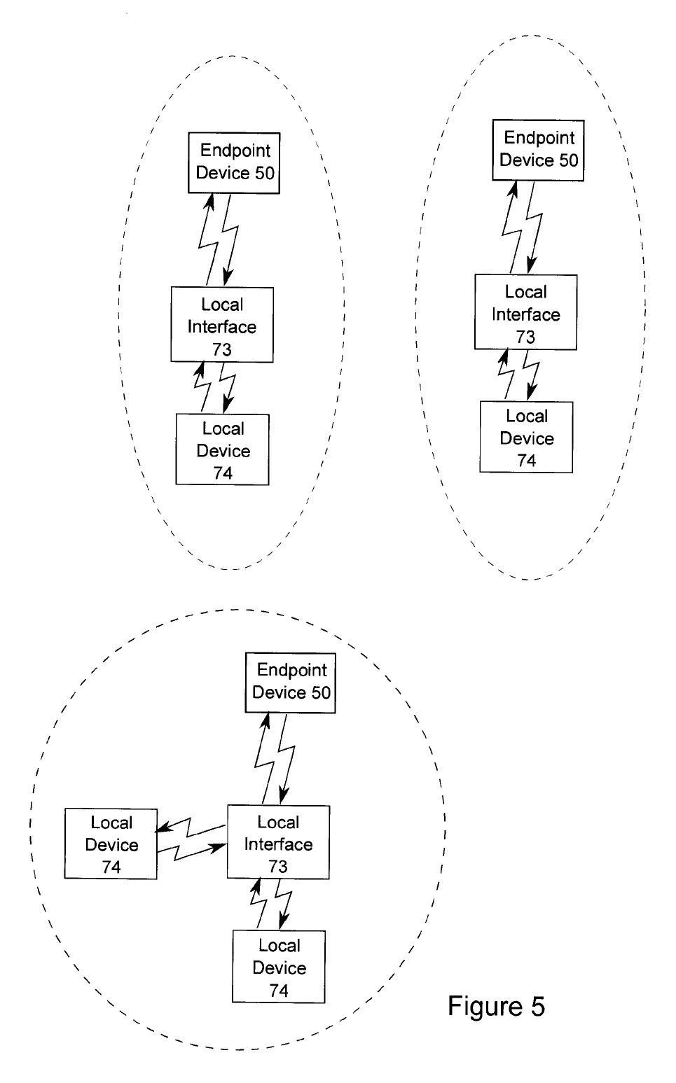

A third network structure is illustrated in FIG. 5, where the server-hub-valve relationship is removed entirely, leaving each valve as separate network on its own. Each of the remote devices communicates only with the local interface in its own network, which in turn maintains operation of the valve. The network is simplified by removing the local interface and allows each remote device to communicate directly with the valve.

The present invention provides many advantages. The present invention allows a utility service to be controlled remotely. In addition, because of the client-server nature of the system, a unique client can be made that would allow emergency services personnel responding to a fire or other emergency the ability to shut off gas or water to a particular site or area. The client software would be granted a unique login/password by the owner of the system and would provide a limited amount of information. Typically, this information would be limited to the address, GPS co-ordinates (which could in-turn be used with other GPS software to provide routing information), and the ability to close the valve.

Furthermore, acting independently, each network access hub 60 can detect an earthquake and instruct all endpoint devices 50 under its control to shut. The alarm threshold would be set according to local jurisdictional requirements (e.g. ASCE 25-06). The network access hub 60 could also instruct other devices, such as horns, signal lights, or barriers to activate as well.

Alternatively, separate wireless devices incorporating earthquake detection could be paired with individual valves or a specific subset of valves relating to the same site. In this case, the valve(s) would respond only to its paired “earthquake detector” rather than to a hub on the network.

The network access hubs 60, as part of a larger network, can communicate their “earthquake” status to the server 70. The server 70 can, in turn, make a decision based on the number or pattern of network access hubs 60 reporting in to instruct other network access hubs 60, which have not yet experienced the earthquake to automatically shut their valves or trigger signalling devices. Since earthquake waves have a finite speed as they propagate outward from the epicentre, but data transmission across a network is nearly instantaneous, the system can spread the message of the impending earthquake faster than the earthquake itself.

By incorporating metering equipment into the system, the network can monitor the usage of a utility (e.g. gas, water, oil, street lighting) at a location, and automatically restrict, or stop, service when a preset quota is reached. This quota can be daily, weekly, monthly, yearly, or arbitrarily set to match a billing cycle or other schedule. For example, a water utility in a desert community could set a daily limit on how much water a location can use, especially during times of drought. If a site reaches its daily quota, then the software can automatically stop service, or restrict the service to 10% to still allow for emergency usage (e.g. enough water to drink, but not enough to run appliances or water the garden). One scenario could see the utility have a soft quota and a hard quota. Reaching the soft quota would trigger a limited service, while reaching the hard quota would trigger a complete shutdown. When the quota period is over, the system would then automatically restore service to all sites that had previously violated the quota.

Furthermore, with metering equipment installed, the system can be set up so that the end customer prepays for its utility service. The software can be configured to provide an automated email, or other electronic message, to the customer when the prepaid service is nearly expired to remind them to prepay for more service, and automatically stop or limit service when the prepaid amount expires.

The system also can be set to provide service for a limited time by date and/or time, or it can be set to only provide service during preset time periods. For example, a construction site that requires gas service but only for a few days can have the service automatically turned on at the start, and then automatically turned off a few days later automatically. Or a utility can offer a service to commercial sites where they would use the system to automatically shut off service after business hours, and restore it during business hours.

A local interface provides access to a singular valve, or specific valves. These valves would still be accessible to the utility over the network; however, through the use of a local interface, the end-user would also be granted a degree of control over his valves without affecting other nearby valves or devices on the main network. This feature can be locked out by the utility so that the customer would be unable to re-open a closed valve without the utility's consent. Sources of actuation could include gas-leak detection, fire alarms, carbon monoxide detection, water leak detection, earthquake detection, and remote opening/closing of device.

This allows the end-user to integrate a safety system at his or her site that takes advantage of the automatic open/close capabilities of the valve without impairing the utility's ability to control the level of service to that site. It also provides peace of mind by providing a means for the end-user to easily close his or her valve when the end-user leaves the site.

Alternatively, the network may be removed leaving the local interface and safety system as the sole controller for the valve. The local interface for the valve can also be integrated into each of the devices on the safety system, allowing each to access the valve independently.

It will be appreciated by those skilled in the art that the preferred and alternative embodiments have been described in some detail but that certain modifications may be practiced without departing from the principles of the invention.

1. A system for remotely operating endpoint devices, said system comprising:
a server;
one or more network access hubs, wherein each of said one or more network access hubs comprises:
a network interface for communication with said server over a network;
a microprocessor;
a hub transmitting means;
an earthquake detection circuit, wherein said earthquake detection circuit sends an earthquake warning to said microprocessor upon detection of a possible earthquake; and
a hub power supply; and
one or more endpoint devices, wherein each of said one or more endpoint devices comprises:
an endpoint receiving means for receiving wireless communications from said hub transmitting means of one or more of said network access hubs in wireless communications range, said wireless communications comprising instructions;
a microcontroller for processing said instructions and executing said instructions; and
an endpoint power supply.

2. The system of claim 1, wherein said hub transmitting means comprise a transceiver.

3. The system of claim 1, wherein said endpoint receiving means comprise a transceiver.

4. The system of claim 1, wherein one or more of said endpoint devices further comprise:
a valve motor for controlling one or more valves; and
a motor driver, wherein said motor driver receives electrical signals from said microcontroller upon execution of said instructions by said microcontroller and wherein said motor driver effects movement of said valve motor in accordance with said electric signals.

5. The system of claim 4, wherein said one or more valves restrict the flow of one of the following utility services: gas, oil, and water.

6. The system of claim 5, wherein said endpoint devices further comprise a valve position detection circuit to send data to said microcontroller regarding position of said one or more valves.

7. The system of claim 1, wherein one or more of said endpoint devices further comprise one or more of the following: sensors, meters, signaling devices, fans, and pumps.

8. (canceled)

9. The system of claim 1, wherein one or more of said endpoint devices further comprise an endpoint tamper detection circuit to send an endpoint tamper warning to said microcontroller upon detection of possible tampering with said endpoint device.

10. The system of claim 1, wherein one or more of said network access hubs further comprise a hub tamper detection circuit to send a hub tamper warning to said microprocessor upon detection of possible tampering with said network access hub.

11. The system of claim 1, wherein one or more of said endpoint devices further comprise a temperature sensor.

12. The system of claim 1, wherein said endpoint power supply comprises a battery.

13. The system of claim 12, wherein said endpoint device further comprises a battery management circuit to send a battery warning to said microcontroller upon detection of a possible failure of said battery.

14. The system of claim 1, wherein one or more of said network access hubs further comprise a backup power supply.

15. The system of claim 14, wherein said network access hubs further comprise a power management circuit to send a power warning to said microprocessor upon detection of a possible failure of said hub power supply or said backup power supply.

16. The system of claim 1, further comprising a database in communication with said server, said database storing information in relation to operation of said system.

17. The system of claim 1, wherein one or more of said endpoint devices comprises a light source for use in street lighting.

18. A method of remotely controlling endpoint devices, said method comprising the steps of:
a server communicating with one or more network access hubs through a network:
said one or more network access hubs wirelessly transmitting instructions to one or more endpoint devices through a hub transmitting means;
said one or more endpoint devices receiving said instructions from said network access hubs through an endpoint receiving means; and
said one or more endpoint devices implementing said instructions.

19. A method of controlling endpoint devices, said method comprising the steps of:
a server communicating with one or more network access hubs through a network;
said one or more network access hubs wirelessly transmitting instructions to one or more endpoint devices through a hub transmitting means;
said one or more endpoint devices receiving said instructions from said network access hubs through a endpoint receiving means;
said one or more endpoint devices receiving other instructions from a local interface connected to said endpoint devices;
said one or more endpoint devices implementing either said instructions or said other instructions, depending on priority of said instructions and said other instructions.

20. A method of remotely controlling a valve in an endpoint device in response to a possible earthquake, said method comprising the steps of:
a server communicating with a network access hub through a network;
said network access hub detecting a possible earthquake through an earthquake detection circuit;
said network access hub transmitting information regarding said possible earthquake to said server through said network;
said network access hub wirelessly transmitting instructions to said endpoint device through a hub transmitting means, said instructions comprising instructions regarding control of said valve in response to said possible earthquake;
said endpoint device receiving said instructions from said network access hub through an endpoint receiving means; and
said endpoint device controlling said valve in accordance with said instructions.
